(19) United States
(12) Patent Application Publication
(10) Pub. No.: US 2004/0091113 A1
(43) Pub. Date: May 13, 2004

(54) Interface apparatus for monitoring encrypted network

(76) Inventor: Daiji Sanai, Shibuya-ku (JP)

Correspondence Address: STEVENS, DAVIS, MILLER & MOSHER, LLP., Suite 850, 1615 L Street, N.W., Washington, DC, 20036, US

(21) Appl. No.: 10/653,162

(22) Filed: Sep. 3, 2003

(30) Foreign Application Priority Data
Sep. 6, 2002 (JP) P2002-260858

(51) Int. Cl. H04L 9/00

(52) U.S. Cl. 380/255; 713/201

(57) ABSTRACT

An interface apparatus is used for a monitoring device, which monitors communication between first and second nodes. The communication is conducted by using an encrypted signal through a network. The interface apparatus includes an encrypted signal interface section, a plaintext interface section, and a code process section. The encrypted signal interface section is connected to the first node through the network. The plaintext interface section is connected to the second node. The code process section decrypts a first signal, which is transmitted from the first node, to transmit the decrypted first signal to the plaintext interface section, and encrypts a second signal, which is transmitted from the second node, to transmit the encrypted second signal to the encrypted signal interface section. The monitoring device monitors a signal transmitted/received by the plaintext interface section.

The present disclosure relates to the subject matter contained in Japanese Patent Application No.2002-260858 filed on Sep. 6, 2002, which is incorporated herein by reference in its entirety.

### BACKGROUND OF THE INVENTION

1. Field of the Invention

The present invention relates to an interface apparatus for monitoring a communication state and other states in a network (hereinafter referred to as “encrypted network”) through which a signal, which is encrypted data, flows.

2. Description of the Related Art

It is feared that a signal flowing on a network as, for example, a packet is wiretapped or falsified. As prevention measures against these unauthorized accesses, there is a technique for encrypting the signal flowing on the network and conducting communication. IPSEC is defined as standard specifications of encryption and has been started to practical use of it. That is, in a publicly known encrypted network, it is constructed so that encryption parameters (for example, both or one of an encryption algorithm and an encryption key) are negotiated between a transmission node of a packet and a reception node of the packet and the packet encrypted based on the parameters is transmitted and received. Therefore, confidentiality of data exchanged therebetween is ensured.

However, in the encrypted network, administrator's disadvantage occurs while improvement in security level can be expected. That is, since a signal exchanged in a form of a packet on the network is encrypted, content of the packet cannot be analyzed in a case of performing a cause analysis of trouble occurring in the network. This is a problem. Also, in a case of monitoring unauthorized access from the outside, since the packet is encrypted, the content of the packet cannot be analyzed. As a result, the unauthorized access cannot be monitored. This is also a problem.

For example, in an encrypted network (a conventional example 1) shown in FIG. 13, when it is necessary to monitor a state of a signal (packet) input to and output from a particular node A, the network connected to the node A is branched and is connected to a monitoring apparatus C. However, a packet, which this monitoring apparatus C can receive, is encrypted, so that the monitoring side cannot find out the content thereof. As a result, administration or monitoring of the network cannot be performed.

Also, in a network (a conventional example 2) in which a plurality sets of nodes communicating with each other using a signal are present as shown in FIG. 14, an encryption parameter is negotiated between two nodes (node pair), which communicate with each other, and an encrypted packet is transmitted and received. For example, nodes A and B, nodes C and D each form node pairs and communication is conducted according to the encryption parameter negotiated between each node pair. In a case of monitoring a state of such a network, even when a packet is received in a monitoring apparatus E connected to the network, since the signal is encrypted, the content thereof cannot be analyzed.

### SUMMARY OF THE INVENTION

An object of the invention is to provide an apparatus capable of monitoring a communication state in an encrypted network.

According to a first aspect of the invention, an interface apparatus is used for a monitoring device (for example, a monitoring apparatus C in FIG. 1), which monitors communication between first and second nodes (for example, nodes A and B in FIG. 1). The communication is conducted by using an encrypted signal through a network. The interface apparatus includes an encrypted signal interface section connected to the first node (for example, the node B in FIG. 1) through the network, a plaintext interface section connected to the second node (for example, the node A in FIG. 1), and a code process section for decrypting a first signal, which is transmitted from the first node and received by the encrypted signal interface section, to transmit the decrypted first signal to the plaintext interface section and encrypting a second signal, which is transmitted from the second node and received by the plaintext interface section, to transmit the encrypted second signal to the encrypted signal interface section.

According to a second aspect of the invention, an interface apparatus is used for a monitoring device (for example, a monitoring apparatus in FIG. 11), which monitors communication among a plurality of nodes (for example nodes A, B, C, and D in FIG. 11). The communication is conducted by using an encrypted signal through a network. The interface apparatus includes a plurality of encrypted signal interface sections connected to the plurality of nodes (for example, the nodes A, B, C, and D in FIG. 11), respectively, through the network, a plaintext interface section connected to the monitoring device, and a plurality of code process sections each for decrypting an encrypted signal transmitted from each of nodes, to transmit the decrypted signal to the monitoring device.

In the first aspect, the code process section of the interface apparatus negotiates an encryption parameter between the interface apparatus and the first node (for example, a node B) of the two nodes connected through the network instead of the second node (for example, a node A) and converts signals transmitted to and received by one node (B). That is, the code process section decrypts encrypted data, which is transmitted from the first node (node B) to the second node (node A) into plaintext data. Also, the code process section encrypts plaintext, which is transmitted from the second node (node A) to the first node (node B). As a result, while confidentiality is ensured by the encrypted signal on the network to which one node (B) is connected, communication by plaintext data is conducted between the interface apparatus and the second node (node A). Therefore, by branching a signal path between the interface apparatus and the second node (node A) and connecting the signal path to the monitoring device (monitoring apparatus C), the monitoring device can monitor signals transmitted from and received by the second node. In this case, the interface apparatus behaves as if to be the second node (A) of a communication partner with respect to the first node (B) connected to the network.

In the second aspect, the interface apparatus is installed in a monitoring position (for example, between nodes A, C and nodes B, D) on the network. Here, in a case of conducting communication between a pair (node pair) of first and second nodes (A and B), the interface apparatus behaves as if to be the second node (B) with respect to the first node (A) and negotiates an encryption parameter between the first node (A) and the interface apparatus and conducts communication encrypted. Also, the apparatus behaves as if to be the first node (A) with respect to the second node (B) and negotiates another encryption parameter between the second node (B) and the interface apparatus and conducts communication encrypted. In any case, the interface apparatus can decrypt a signal transmitted from and received by the first node (A) or the second node (B) based on these predetermined encryption parameters. Monitoring plaintext data as it is can be performed by outputting data converted into plaintext data in the interface apparatus thus to the monitoring device. The interface apparatus performs similar processing with respect to communication between another pair of nodes (C and D) or the other nodes and monitoring the plain text as it is can be performed.

### BRIEF DESCRIPTION OF THE DRAWINGS

FIG. 1 is a diagram showing a network configuration of a case where an interface apparatus according to a first embodiment of the invention is applied to a conventional encrypted network.

FIG. 2 is a diagram showing a configuration of the interface apparatus according to the first embodiment.

FIG. 3 is a diagram showing an example of encrypted data (Data1) transmitted to destinations of an IP address “a” and an HW address “AA”.

FIG. 4 is a diagram showing an example of plaintext data “Data2” obtained by decrypting the encrypted data “Data1” of FIG. 3.

FIG. 5 is a diagram showing an example of a plaintext in which an IP address “a” of a destination and an IP address “b” of a transmission source are added to the plaintext data “Data2” of FIG. 4.

FIG. 6 is a diagram showing plaintext data transmitted as a transmission source HW address “D”, to a destination HW address “A”.

FIG. 7 is a diagram showing plaintext data (Data3) transmitted to destinations of a destination HW address “D” and an IP address “b”.

FIG. 8 is a diagram showing an example of a plaintext in which a destination IP address “b” and a transmission source IP address “a” are added to the plaintext data “Data3”.

FIG. 9 is a diagram showing encrypted data “Data4” transmitted to a destination IP address “b”.

FIG. 10 is a diagram showing the encrypted data “Data4” transmitted as a destination HW address “B” and a transmission source HW address “AA”.

FIG. 11 is a diagram showing a network configuration of a case where an interface apparatus according to a second embodiment of the invention is applied to a conventional encrypted network communicating among a plurality of nodes.

FIG. 12 is a diagram showing a configuration of the interface apparatus according to the second embodiment.

FIG. 13 is a diagram showing a method of monitoring in an encrypted network of a conventional example.

FIG. 14 is a diagram showing an example of a conventional network in which a plurality sets of nodes communicating by using a encrypted signal are present.

### DETAILED DESCRIPTION OF THE PREFERRED EMBODIMENT

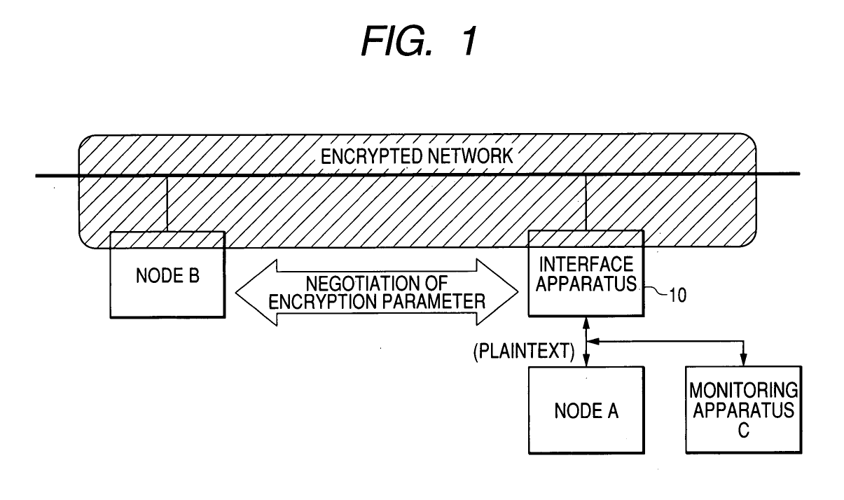

FIG. 1 shows a network configuration when an interface apparatus according to a first embodiment of the invention is applied to the encrypted network of the conventional example 1. In this case, in order to monitor a state of a signal (packet) input to and output from a particular node A through the network, the interface apparatus 10 is interposed between the network and the node A and a signal path between the interface apparatus 10 and the node A is branched and is connected to a monitoring apparatus C. In this configuration, the interface apparatus 10 negotiates an encryption parameter between the interface apparatus 10 and a node B of a communication partner instead of the node A. The interface apparatus 10 can transmit/receive an encrypted signal to/from the node B through the network to ensure confidentiality, while the interface apparatus 10 can communicate with the node A with converting the encrypted signal into a plaintext. As a result of this, the monitoring apparatus C can monitor the signal transmitted from and received at the node A. Therefore, the interface apparatus 10 has a feature of behaving as if to be the node A with respect to the node B connected through the network.

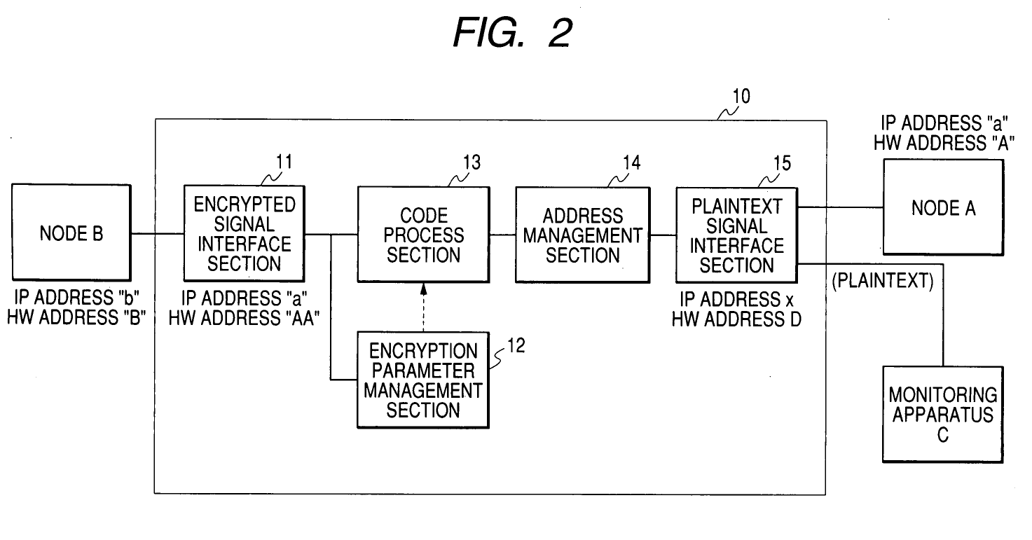

As shown in FIG. 2, the interface apparatus 10 includes an encrypted signal interface section 11 (hereinafter, the “interface” is referred to as an “IF”), an encryption parameter management section 12, a code process section 13, an address management section 14, and a plaintext IF section 15. The encrypted signal interface section 11 is connected to the node B through the network. The encryption parameter management section 12 holds an encryption parameter (an encryption algorithm or an encryption key) negotiated with a communication partner. The code process section 13 decrypts the encrypted signal, which is transmitted from the node B and is received by the encrypted signal IF section 11, into a plaintext on the basis of the encryption parameter held in the encryption parameter management section 12. The code process section 13 also encrypts a plaintext transmitted from the node A. In the specification, the plaintext and plaintext data represent a signal and data, which are not encrypted. The address management section 14 adds an IP address of a destination and an IP address of a transmission source to a plaintext data transmitted from and received by the node A. The plaintext IF section 15 is connected to the node A. The interface apparatus 10 is implemented by a computer, which stores a program for making hardware resources such as a CPU or a peripheral device of a personal computer function as the sections described above.

An operation of the interface apparatus 10 constructed as described above will be described. Incidentally, IP addresses and hardware (hereinafter described as “HW”) addresses of the node A and the node B, which communicate with each other through the network as described above, are assumed to be “a” and “A”, and “b” and “B”, respectively.

1) When Transmitting Data from Node B to Node A

First, in order to find out an HW address of the node A of a communication partner, the node B performs address resolution process by using the address resolution protocol (ARP) and obtains an HW address “AA” of the encrypted signal IF section 11 of the interface apparatus 10 as an HW address corresponding to an IP address “a”. This is because since the encrypted signal IF section 11 has the same IP address as the node A in this case, the HW address obtained by the node B is not an HW address “A” of the node A but the HW address “AA” of the encrypted signal IF section 11. Here, the address resolution using the ARP is achieved in the following manner. The node B (transmission side) broadcasts an ARP request message toward a destination (in this case, the node A) and in response to this, the destination side sends back an HW address and the transmission side (in this case, the node B) captures this reply.

Next, the node B exchanges data to negotiate an encryption parameter with respect to the IP address “a” and the HW address “AA”. As a result of this, the interface apparatus 10 holds an encryption parameter common to the node B in the encryption parameter management section 12.

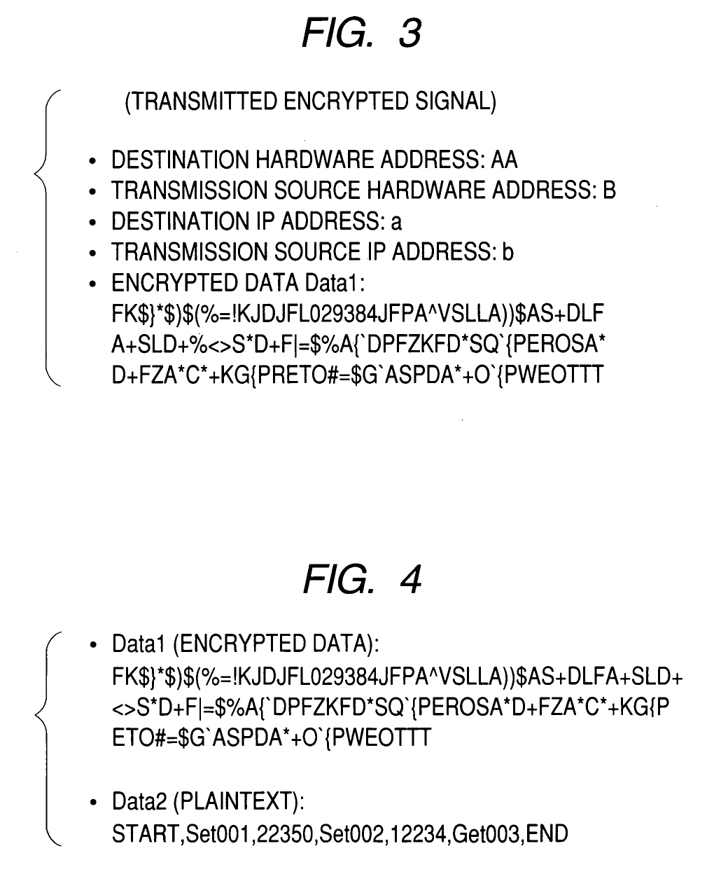

Thereafter, as shown in FIG. 3, the node B encrypts transmission data according to the common encryption parameter and transmits the encrypted data (Data1) to the IP address “a” and the HW address “AA”.

With respect to the encrypted signal transmitted in this manner, the interface apparatus 10 decodes “Data1” using the encryption parameter already negotiated in the code process section 13 and obtains “Data2” decrypted as shown in FIG. 4.

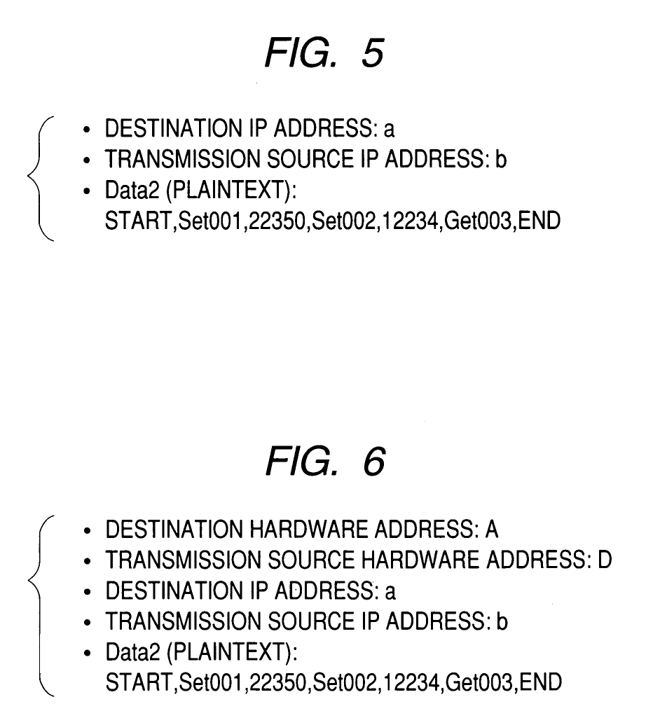

As shown in FIG. 5, the address management section 14 adds the IP address “a” of a destination and an IP address “b” of a transmission source to this plaintext data “Data2” and passes the data to the plaintext IF section 15.

As shown in FIG. 6, the plaintext IF section 15 performs the address resolution of the node A (IP address “a”) and obtains the HW address “A” thereof. Then, the plaintext IF section 15 transmits the data, which indicates a transmission source HW address is “D” and the destination HW address is “A”, to the node A. Simultaneously, the plaintext IF section 15 also transmits the same data to the monitoring apparatus C and the monitoring apparatus C can monitor this transmitted data.

2) When Transmitting Data from Node A to Node B

First, the node A attempts to perform the address resolution of an IP address “b” of the node B. At this time, the interface apparatus 10 makes a reply (proxy reply) instead of the node B.

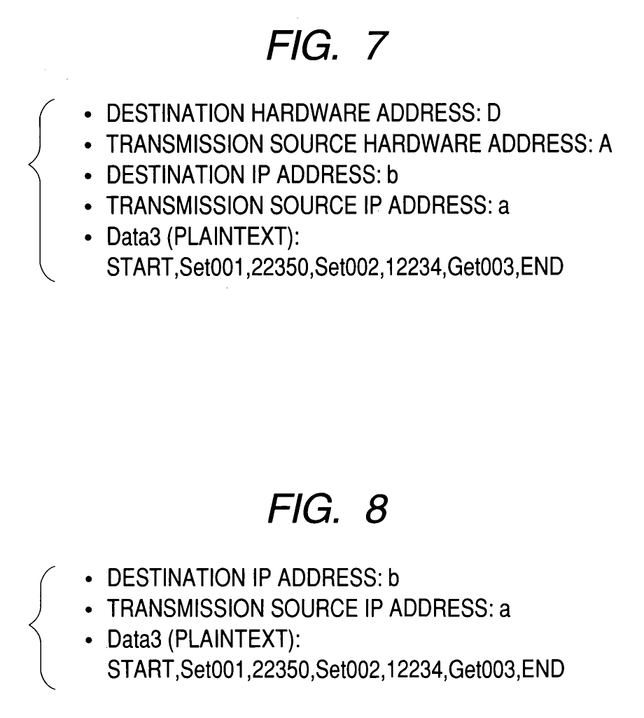

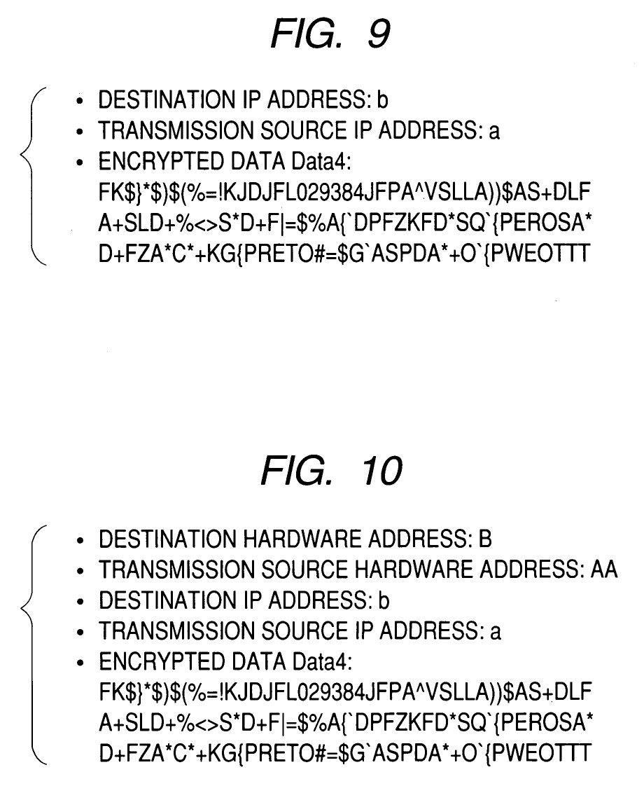

The node A performs the address resolution of the IP address “b” and obtains an HW address “D” of the plaintext IF section 15 as a proxy HW address. Then, as shown in FIG. 7, plaintext data (Data3) is transmitted to the destination HW address “D” and the IP address “b”.

The plaintext IF section 15 transmits the plaintext data received from the node A to a signal path connected to the monitoring apparatus C. As a result, the monitoring apparatus C can obtain the plaintext data “Data3”, which the node A has transmitted to the node B.

As shown in FIG. 8, the address management section 14 adds a destination IP address “b” and a transmission source IP address “a” to the data “Data3” received from the plaintext IF section 15 and passes the data to the code process section 13. If necessary, the encryption parameter management section 12 negotiates the encryption parameter between the destination IP address “b” and the interface apparatus 10. The code process section 13 encrypts the “Data3” on the basis of the encryption parameter (the encrypted “Data3” is referred to as “Data4”) and passes “Data4” to the encrypted signal IF section 11.

The encrypted signal IF section 11 obtains a HW address “B” corresponding to the IP address “b” by the address resolution and transmits the encrypted data “Data4” which indicates the destination HW address “B” and a transmission source HW address “AA” as shown in FIG. 10.

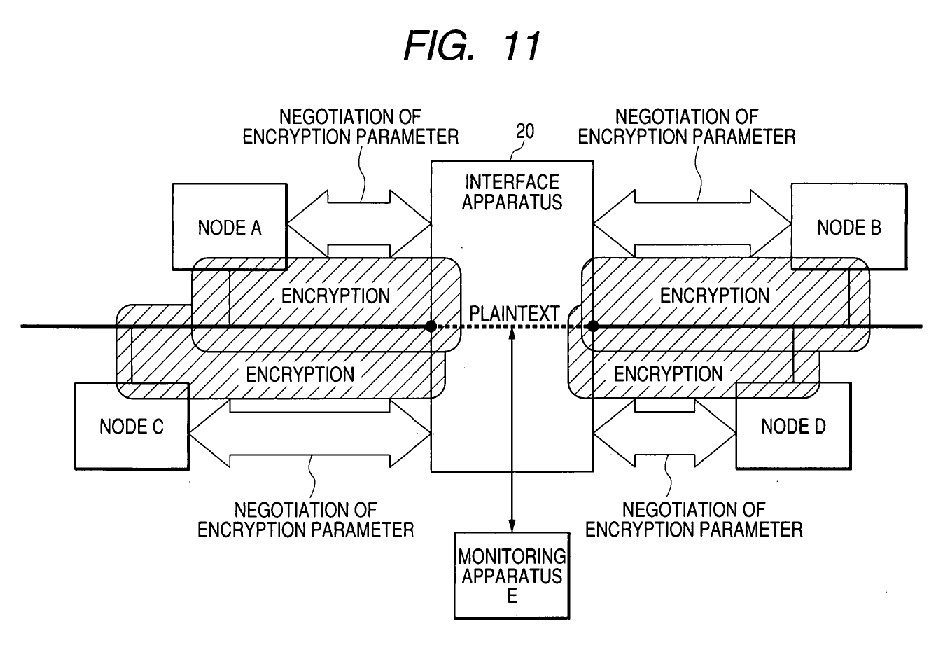

Next, FIG. 11 shows a case where an interface apparatus 20 according to a second embodiment of the invention is applied to the encrypted network of the conventional example 2. In this case, the interface apparatus 20 is installed in a position (among plural nodes A, C and nodes B, D in this example) where the network is monitored.

Of the plurality of nodes connected to the network, assuming that, for example, communication is performed between the node A and the node B. The interface apparatus 20 behaves as if to be the node B, with respect to the node A. The interface apparatus 20 negotiates an encryption parameter between the interface apparatus 20 and the node A to perform the encrypted communication with the node A. The interface apparatus 20 may decrypt this communication on the basis of the encryption parameter. Also, the interface apparatus 20 behaves as if to be the node A, with respect to the node B. The interface apparatus 20 negotiates another encryption parameter between the interface apparatus 20 and the node B to perform the encrypted communication with the node B. Similarly, the interface apparatus 20 may decrypt this communication on the basis of the another encryption parameter.

As described above, the interface apparatus 20 negotiates different encryption parameters between one node pair (for example, the node A) and the interface apparatus 20 and between the other node pair (for example, the node B) and the interface apparatus 20 to perform communication. Inside the apparatus 20, data is exchanged as plaintext data. This data is branched and output to a monitoring apparatus E. Thereby, monitoring in the plaintext data can be performed.

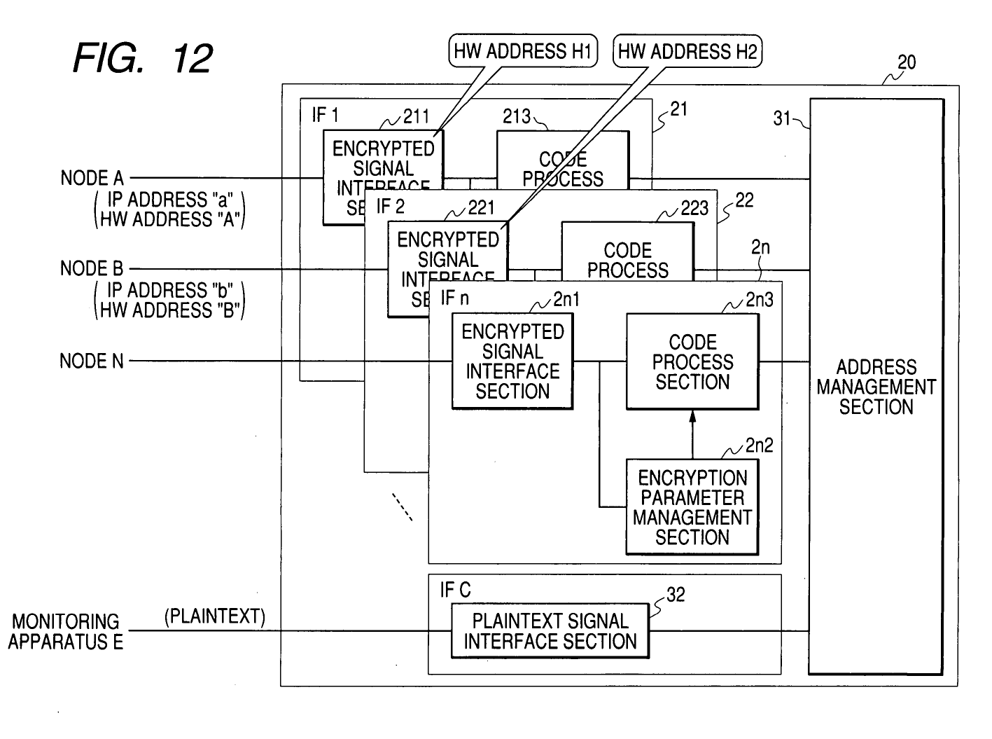

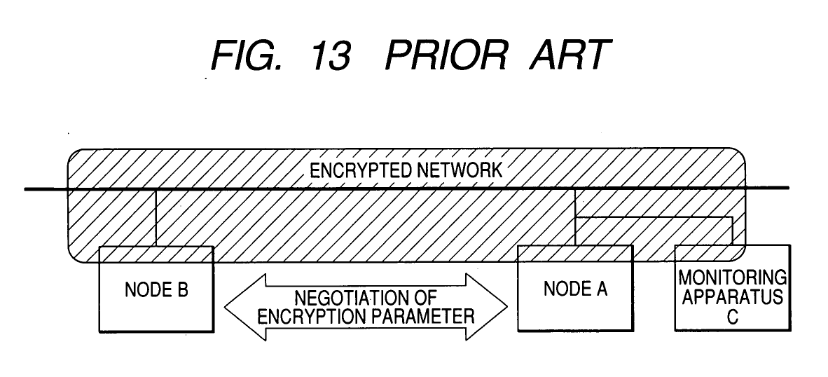

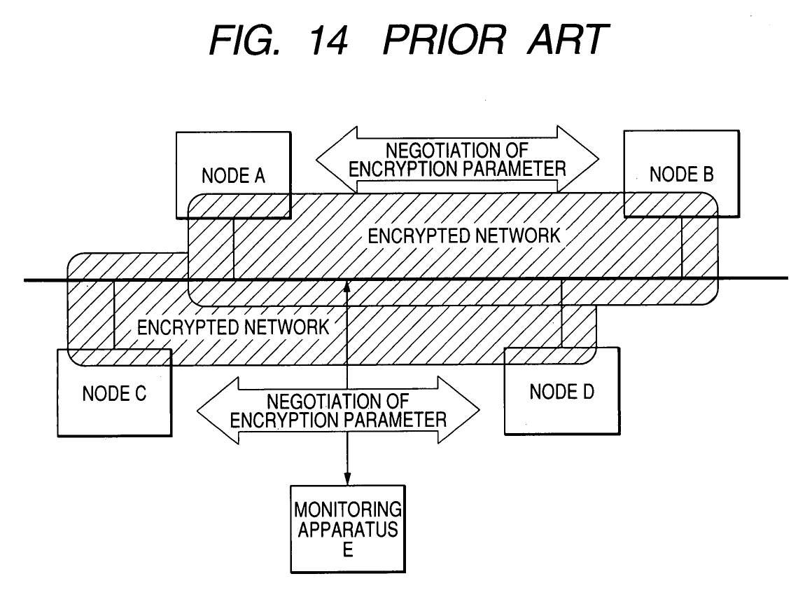

As shown in FIG. 12, the interface apparatus 20 includes a plurality of node side interfaces (IF1, IF2, . . . , IFn) 21, 22, . . . , 2n connected to each of a plurality of nodes A, B, . . . , N through the network, an address management section 31 for adding an IP address of a destination and an IP address of a transmission source to data, which is transmitted and received between a node of a communication partner and the address management section 31, and an plaintext IF section 32 connected to the monitoring apparatus E.

The node side interfaces 21, 22, . . . , 2n include encrypted signal IF sections 211, 221, . . . , 2n1, encryption parameter management sections 212, 222, . . . , 2n2, and code process sections 213, 223, . . . , 2n3. The encrypted signal IF sections 211, 221, . . . 2n1 holds encryption parameters (encryption algorithms or encryption keys) negotiated with a communication partner. The code process sections 213, 223, . . . , 2n3 decrypts an encrypted signal, which is transmitted from each of nodes and received by the encrypted signal IF sections 211, 221, . . . 2n1 on the basis of the encryption parameters held in the encryption parameter management sections 212, 222, . . . 2n2, respectively. The code process sections 213, 223, . . . , 2n3 also encrypts a plaintext, which is transmitted from the address management section 31 on the basis of the encryption parameters held in the encryption parameter management sections 212, 222, . . . , 2n2, respectively. The interface apparatus 20 is also implemented by a computer, which stores a program for making hardware resources such as a CPU or a peripheral device of a personal computer function as the above described sections.

When data is transmitted from the node A to the node B, an operation of the apparatus 20 constructed as described above is as follows.

First, the node A broadcasts an ARP request with respect to an IP address “b” in order to perform the address resolution of the node B.

The encrypted signal IF section 211 of the interface apparatus 20 receives the ARP request and passes the ARP request to the address management section 31. The address management section 31 issues an instruction to the encrypted signal IF sections other than the encrypted signal IF section (in this case, the encrypted signal IF section 211), which receives the ARP request, to transmit the address resolution request from the IP address “a” to the IP address “b”. Each of encrypted signal IF sections receiving the instruction broadcasts a ARP (address resolution request) packet in which the IP address “a” is set to be a source IP address, the IP address “b” is set to be a destination IP address, and a transmission source HW address is set to be an HW address of each encrypted signal IF section.

In response to this address resolution request packet, the encrypted signal IF section (here, the encrypted signal IF section 221) to which the node B is connected receives an ARP reply packet from the node B. The address management section 31 finds out that a node of the IP address “b” is a node connected to the IF part 221 and the HW address thereof is “B”, and stores these. Then, the address management section 31 passes the ARP reply packet from the node B to the encrypted signal IF section 211 to which the request source is connected.

The encrypted signal IF section 211 rewrites both a transmission source HW address in the ARP reply packet transmitted from the IP address “b” and a transmitter HW address of the ARP response into the HW address H1 of the encrypted signal IF section 211 itself. Also, the encrypted signal IF section 211 rewrites both a destination HW address and a target HW address of the ARP response into an HW address “A”. Then, the encrypted signal IF section 211 transmits the ARP reply packet to the node A.

By these processing, the node A recognizes that the encrypted signal IF section 211 of the interface apparatus 20 is the node B, and the node B recognizes that the encrypted signal IF section 221 of the interface apparatus 20 is the node A.

As a result, the node A negotiates an encryption parameter between the encryption signal IF section 211 of the apparatus 20 and the node A, encrypts plaintext data on the basis of the negotiated encryption parameter, and transmits the encrypted data to the interface apparatus 20. The encrypted data passes through the encrypted signal IF section 211 of the interface apparatus 20 and is decoded by the subsequent code process section 213 into plaintext data. Then, this plaintext data is passed to the address management section 31. The address management section 31 delivers the decrypted plaintext data to the plaintext IF section 32 connected to the monitoring apparatus E and the node side IF 21 to which the node B is connected.

The monitoring apparatus E monitors the plaintext data transmitted from the plaintext IF section 32 to the monitoring apparatus E as it is. On the other hand, the plaintext data transmitted to the node side IF section 21 is encrypted on the basis of the encryption parameter negotiated with the node B in the code process section 213 and is transmitted to the node B.

The operation of the second embodiment has been described on the case of transmitting data from the node A to the node B. In a case of transmitting and receiving data between the other nodes, similar operation is performed in each the node side IF section, the address management section and the plaintext IF section of the interface apparatus 20.

What is claimed is:

1. An interface apparatus for a monitoring device, which monitors communication between first and second nodes through a network, wherein the communication is conducted by using an encrypted signal, the interface apparatus comprising:
an encrypted signal interface section connected to the first node through the network;
a plaintext interface section connected to the second node; and
a code process section for:
decrypting a first signal, which is transmitted from the first node and is received by the encrypted signal interface section, to transmit the decrypted first signal to the plaintext interface section; and
encrypting a second signal, which is transmitted from the second node and is received by the plaintext interface section, to transmit the encrypted second signal to the encrypted signal interface section.

2. The interface apparatus according to claim 1, wherein the code process section is disposed between the encrypted signal interface section and the plaintext interface section.

3. The interface apparatus according to claim 1, wherein:
the first signal is an encrypted signal; and
the second signal is a plaintext.

4. The interface apparatus according to claim 1, further comprising:
an encryption parameter management section for holding an encryption parameter negotiated with the first node, wherein:
the code process section decrypts the first signal and encrypts the second signal on the basis of the encryption parameter held in the encryption parameter management section.

5. The interface apparatus according to claim 1, wherein:
the plaintext interface section is connected to the monitoring device; and
the plaintext interface section transmits the decrypted second signal to the monitoring device.

6. An interface apparatus for a monitoring device, which monitors communication among a plurality of nodes through a network, wherein the communication is conducted by using an encrypted signal, the interface apparatus comprising:
a plurality of encrypted signal interface sections connected to the plurality of nodes, respectively, through the network;
a plaintext interface section connected to the monitoring device; and
a plurality of code process sections each for decrypting an encrypted signal transmitted from each of nodes, to transmit the decrypted signal to the monitoring device.

7. The interface apparatus according to claim 6, wherein each of code process sections is disposed between the each of encrypted signal interface sections and the plaintext interface section.

8. The interface apparatus according to claim 6, further comprising:
a plurality of encryption management sections for each holding an encryption parameter negotiated with each of nodes, wherein:
each of code process sections decrypts the encrypted signal on the basis of the encryption parameter held in each of encryption parameter management sections.

9. An interface method for a monitoring device, which monitors communication between first and second nodes through a network, wherein the communication is conducted by using an encrypted signal, the method comprising:
receiving a first signal from the first node;
decrypting the first signal;
transmitting the decrypted first signal to the monitoring device; and
receiving a second signal from the second node;
encrypting the second signal; and
transmitting the encrypted second signal to the first node.

10. An interface method for a monitoring device, which monitors communication among a plurality of nodes through a network, wherein the communication is conducted by using an encrypted signal, the method comprising:
receiving encrypted signals from the plurality of nodes;
decrypting the received encrypted signal; and
transmitting the decrypted signal to the monitoring device.
